(19) United States
(12) Patent Application Publication
(10) Pub. No.: US 2024/0077351 A1
(43) Pub. Date: Mar. 7, 2024

(54) WATER LEVEL DETECTION METHOD VIA VIDEO RECOGNITION

(71) Applicant: IRONYUN INC., Zhubei City (TW)

(72) Inventors: Chia-Ming CHANG, Zhubei City (TW); Paul Kuei-Ker SUN, Zhubei City (TW)

(21) Appl. No.: 17/901,146

(22) Filed: Sep. 1, 2022

(51) Int. Cl. G01F 23/80; G06K 7/14; G06T 7/00

(52) U.S. Cl. CPC G01F 23/804; G06K 7/1417; G06K 7/1443; G06T 7/0002; G08B 21/182

(57) ABSTRACT

A water level detection method via video recognition, includes steps of obtaining an image of a water level gauge from a camera; wherein the water level gauge includes multiple two-dimensional barcodes; and determining a water level according to the two-dimensional barcodes. When a body of water partly covers the water level gauge, the body of water would cover some of the two-dimensional barcodes, leaving the rest of visible two-dimensional barcodes corresponding to the water level. When the water is clear, the two-dimensional barcodes underwater would be visible yet at the same time indecipherable due to distorted barcode scales. This way, the present invention is able to avoid accidentally counting two-dimensional barcodes underwater, and thus more accurately and robustly detect water levels.

### BACKGROUND OF THE INVENTION

### 1. Field of the Invention

The present invention relates to a water level detection method, more particularly a water level detection method via video recognition.

### 2. Description of the Related Art

In the past, detection of water levels involves visual confirmation of water line contrasted over a water level gauge. This visual confirmation is either executed by the human eyes, or by software means over a surveillance footage of the water over the water level gauge.

While visual confirmation via the human eyes is too exhausting on human resources, the detection of water levels using software means is still far from perfect. Namely, currently the detection of water levels using software means often uses a count of water level lines on the water level gauge to obtain water levels. This however may be inaccurate as water level lines may be visible and falsely counted in clear water.

Due to the above concerns, a more accurate and robust software means of detecting water levels should be introduced to improve upon the method of water level detection.

### SUMMARY OF THE INVENTION

The present invention provides a water level detection method via video recognition. The present invention is able to more accurately calculate water levels.

The water level detection method via video recognition includes the following steps:
step S10: obtaining an image of a water level gauge from a camera; wherein the water level gauge includes multiple two-dimensional barcodes;
step S20: determining a water level according to the two-dimensional barcodes.

When water partly covers the water level gauge, the body of water would cover some of the two-dimensional barcodes, leaving the rest of visible two-dimensional barcodes corresponding to the water level. This way, the present invention is able to improve upon previously existing water level detection methods, to more accurately and robustly detect water levels.

### BRIEF DESCRIPTION OF THE DRAWINGS

FIG. 1 is a block diagram of a water level monitoring system.

FIG. 2 is a perspective view of the water level monitoring system executing a water level detection method via video recognition of the present invention.

FIG. 3 is a flow chart of the water level detection method via video recognition of the present invention.

FIG. 4 is a perspective view of light deflection of an underwater QR code.

FIG. 5 is a perspective view of light reflection of an above water QR code.

FIG. 6 is a flow chart of a first embodiment of the water level detection method via video recognition of the present invention.

FIG. 7 is a flow chart of a second embodiment of the water level detection method via video recognition of the present invention.

FIG. 8 is a flow chart of a third embodiment of the water level detection method via video recognition of the present invention.

### DETAILED DESCRIPTION OF THE INVENTION

The present invention provides a water level detection method via video recognition.

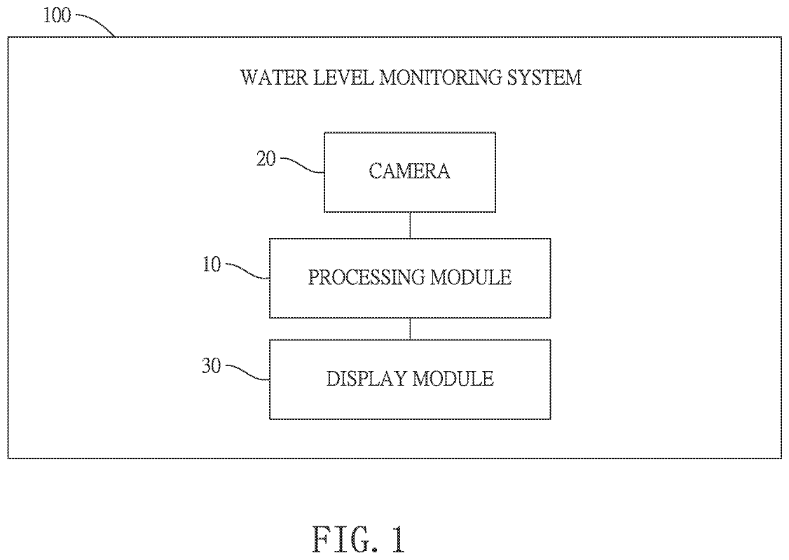

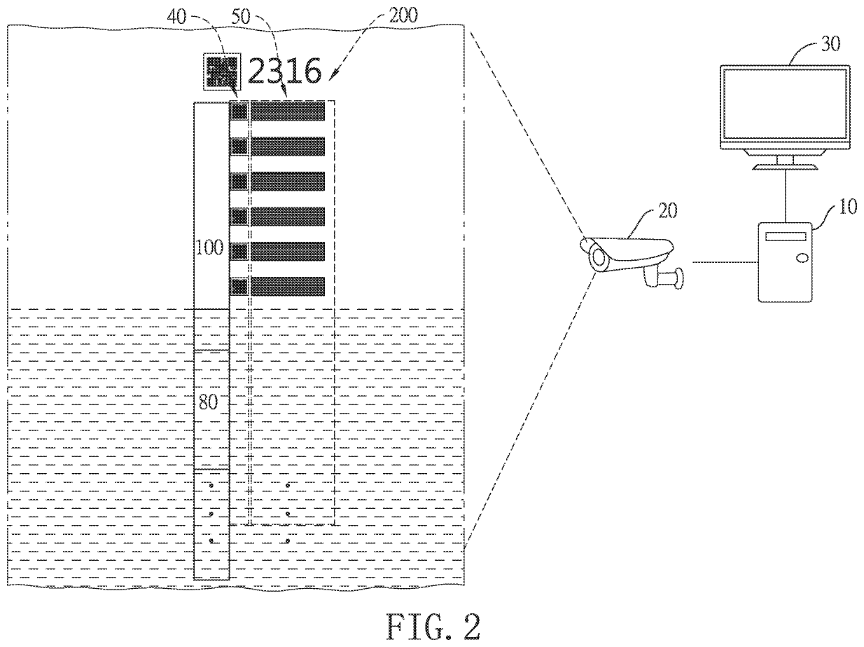

With reference to FIGS. 1 and 2, the water level detection method via video recognition is executed by a processing module 10 of a water level monitoring system 100. The processing module 10 is connected to a camera 20 facing a water level gauge 200 in a body of water. Furthermore, the processing module 10 is also connected to a display module 30 for displaying footage of the body of water and any related notifications regarding water levels of the body of water.

The water level gauge 200 includes multiple two-dimensional barcodes 40. In a first embodiment of the present invention, more particularly, the two-dimensional barcodes 40 are arranged in a parallel array on the water level gauge 200 along with water level lines 50 of the water level gauge 200.

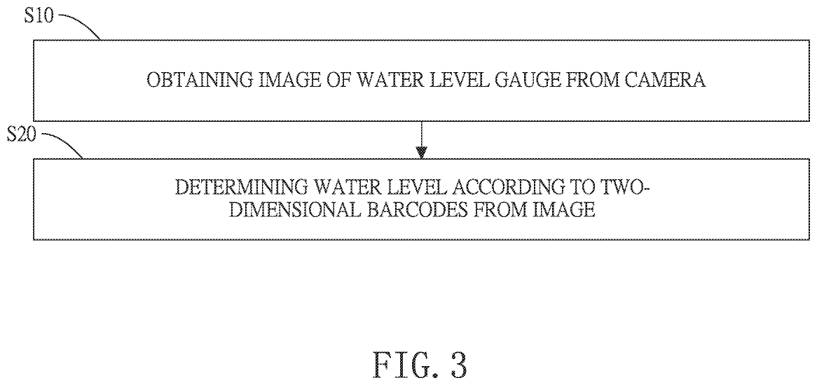

With reference to FIG. 3, the water level detection method via video recognition of the present invention includes the following steps:
Step S10: obtaining an image of the water level gauge 200 from the camera 20.
Step S20: determining a water level according to the two-dimensional barcodes 40 from the image.

By using the camera 20, the present invention enables the possibility of reading multiple barcodes all at once from the image, and thus is able to determine water levels from the two-dimensional barcodes 40. The camera 20 functions as an image-based reader for the two-dimensional barcodes 40 of the present invention. A water level gauge would have multiple one-dimensional barcodes. These one-dimensional barcodes may only be scanned one at a time by a laser scanner and such limitation is inefficient for gathering live information about water levels. In the present embodiment, the image used for determining water levels is the footage gathered live by the camera 20. Furthermore, all of the two-dimensional barcodes 40 of the water level gauge 200 are identical quick response (QR) codes.

Although it is possible for multiple laser scanners to scan multiple one-dimensional codes simultaneously, but such way of detecting water level is very cost inefficient. An image-based reader such as the camera 20 can technically read multiple one-dimensional barcodes at once, but reading multiple one-dimensional barcodes is problematic as one-dimensional barcodes above the water can easily reflect from the water surface into the camera 20, and the one-dimensional barcodes underwater can easily refract through the body of water into the camera 20. These reflected or refracted one-dimensional barcodes can easily be confused with an actual reading of the water level, as one-dimensional barcodes lack reference points the two-dimensional barcodes 40 have to distinguish refracted, reflected, and actual readings of the one-dimensional barcodes apart. The reference points of the two-dimensional barcodes 40, in the case of QR codes, is a positioner in each of the QR codes on the water level gauge 200.

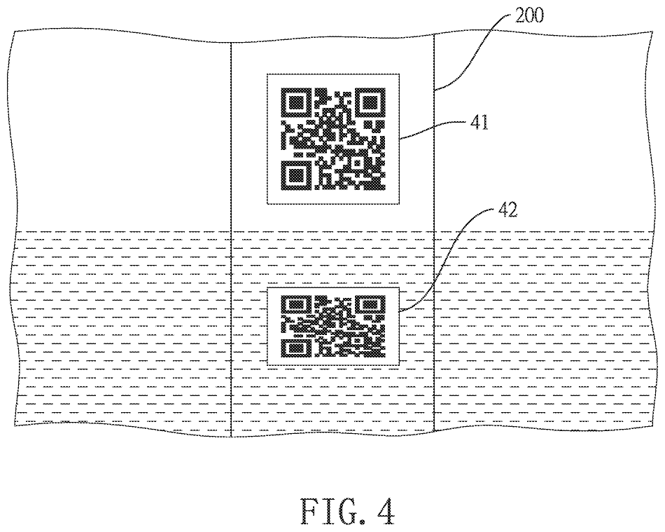

With reference to FIG. 4, when water partly covers the water level gauge 200, the body of water would cover some of the two-dimensional barcodes 40, leaving the rest of visible two-dimensional barcodes 40 corresponding to the water level. When the water is clear, the two-dimensional barcodes 40 underwater would be visible yet at the same time indecipherable due to distorted barcode scales. As presented in FIG. 4, an above water QR code 41 and an underwater QR code 42 are identical QR codes from the two-dimensional barcodes 40. However, when viewed in the image, the underwater QR code 42 is distorted as light deflection happens across two media and has different scales from the above water QR code 41. This difference allows the present invention to improve upon previously existing water level detection methods, to more accurately and robustly detect water levels. In other words, although the underwater QR code 42 is visible from above in perfectly still and transparent water, the height and length of the underwater QR code 42 would be distorted, and thus become unrecognizable. In reality, the water is in fact more likely to be somewhat opaque, somewhat flowing, which makes for conditions even harder for the underwater QR code 42 to be recognized. For this reason the water level detection method via video recognition of the present invention is systematically more robust and more accurate to figure out the water levels.

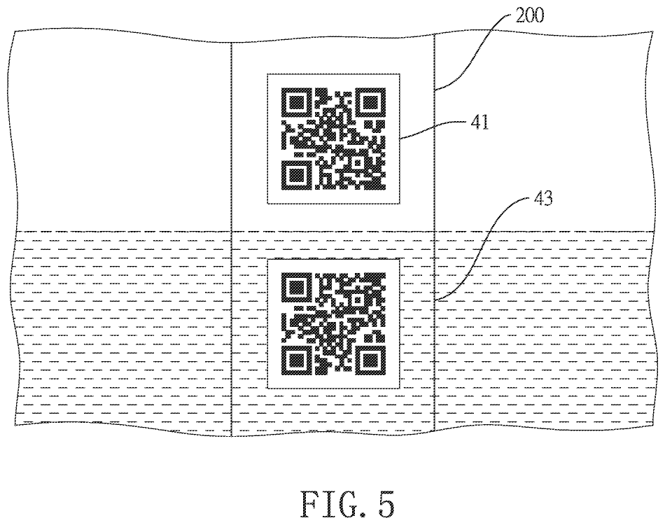

With reference to FIG. 5, in a situation when the water is completely opaque and very reflective, prior arts may have inaccurate readings, as water level lines on a water level gauge may be reflected into the camera. This problem is avoided in the present invention. In FIG. 5, the above water QR code 41 and a reflected QR code 43 are in fact mirrored images of identical QR codes from the two-dimensional barcodes 40. However, when the above water QR code 41 is mirrored to be the reflected QR code 43, the reflected QR code 43 would be different from the non-mirrored one. More particularly, the positioners on QR codes would be mirrored differently, so as to specify a directional change in QR code positions. When all of the two-dimensional barcodes 40 of the water level gauge 200 are identical QR codes, the reflected QR codes would be different and differentiated from the non-reflected ones. For this reason, the water level detection method via video recognition of the present invention is systematically more robust and more accurate to figure out the water levels.

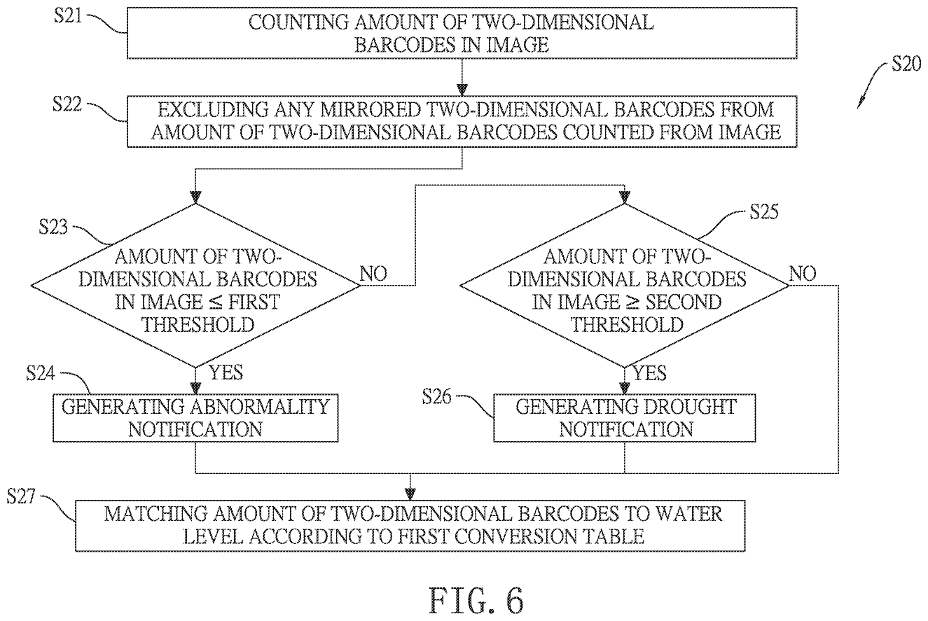

With reference to FIG. 6, step S20 further includes the following sub-steps:
Step S21: counting an amount of two-dimensional barcodes 40 in the image.
Step S22: excluding any mirrored two-dimensional barcodes from the amount of the two-dimensional barcodes 40 counted from the image.
Step S23: determining whether the amount of the two-dimensional barcodes 40 in the image is less than or equal to a first threshold.
Step S24: if determining the amount of the two-dimensional barcodes is less than or equal to the first threshold, generating an abnormality notification and then executing step S27.
Step S25: if determining the amount of the two-dimensional barcodes 40 is greater than the first threshold, further determining whether the amount of the two-dimensional barcodes 40 in the image is greater than or equal to a second threshold.
Step S26: if determining the amount of the two-dimensional barcodes 40 is greater than or equal to the second threshold, generating a drought notification and then executing step S27.

If determining the amount of the two-dimensional barcodes 40 is less than the second threshold, directly executing step S27.

Step S27: matching the amount of the two-dimensional barcodes 40 to the water level according to a first conversion table.

Step S21 is executed by reading an amount of QR codes in the image without deciphering encoded message of the QR codes. This way processing requirement is kept relatively low, allowing the present invention to consume less energy.

Step S22 is included to exclude any potential rare case of having accidentally counted mirrored two-dimensional barcodes 40. These rare cases may happen if somehow the two-dimensional barcodes 40 are symmetric, allowing mirrored and non-mirrored two-dimensional barcodes 40 to look the same. For example, if the two-dimensional barcodes 40 are concentrically symmetric rings, mirrored and non-mirrored images of these rings might be indistinguishable. In the case of the two-dimensional barcodes 40 being QR codes, this problem should be avoided as QR codes have positioners in place, allowing mirrored and non-mirrored QR codes to be differentiated.

The first threshold and the second threshold are values stored within the processing module 10, with the first threshold being less than the second threshold. In step S24, when determining the amount of the two-dimensional barcodes 40 is less than or equal to the first threshold, the processing module 10 then determines that logically the water should be very full, leaving barely any two-dimensional barcodes 40 visible. The abnormality notification signifies that either flood is imminent, or perhaps the camera 20 has malfunctioned, such as blocked by a bird, leaving barely any two-dimensional barcodes 40 visible to the camera 20.

When determining the amount of two-dimensional barcodes 40 is both greater than the first threshold and greater than or equal to the second threshold as in step S26, the processing module 10 then determines that logically the water should be almost empty in a containment of the body of water, and thus should generate the drought notification.

After generation, the abnormality notification or the drought notification is displayed to a user via the display module 30. The abnormality notification and the drought notification may be a status report, or an alarming message, and is free to be elsewise in other embodiments.

The first conversion table is stored within the processing module 10, and in this embodiment, the first conversion table is as below:

First conversion table

| The amount of two-dimensional | |
|---|---|
| barcodes visible in the image | Water Level |
| 0 | Over 5 meters (m) |
| 1 | Between 4 m and 5 m |
| 2 | Between 3 m and 4 m |
| 3 | Between 2 m and 3 m |
| 4 | Between 1 m and 2 m |
| 5 | Less than 1 m |

For example, if the amount of the two-dimensional barcodes 40 visible in the image and counted by the processing module 10 is 3 QR codes, then when the processing module 10 executes step S27 to match the amount of the two-dimensional barcodes 40 to the water level according to the first conversion table, the processing module 10 determines that the water level is between 2 and 3 meters for the body of water.

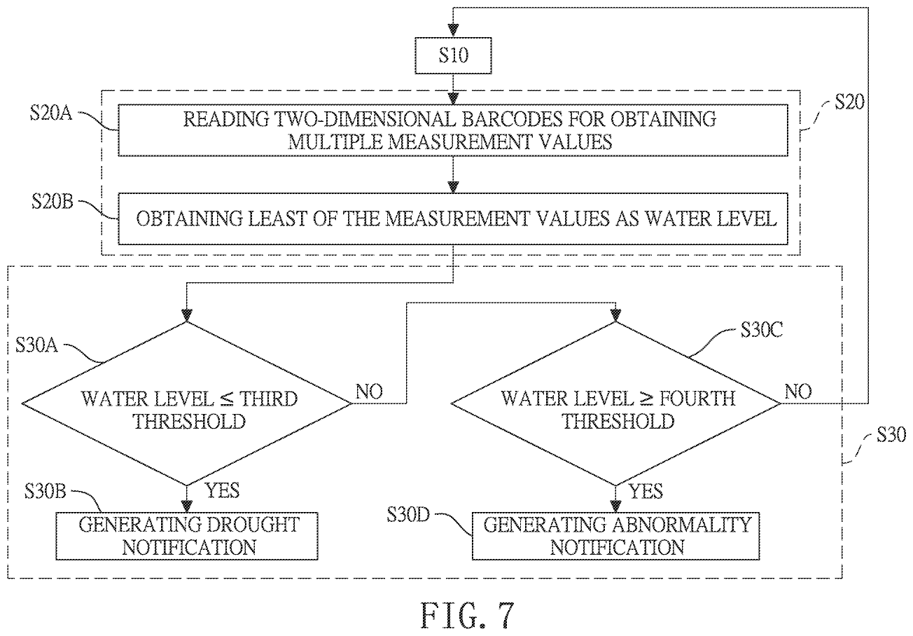

With reference to FIG. 7, in a second embodiment of the present invention, the step S20 further includes the following sub-steps:
Step S20A: reading the two-dimensional barcodes 40 for obtaining multiple measurement values.
Step S20B: obtaining the least of the measurement values as the water level.

Furthermore, the water level detection method via video recognition further includes the following steps:
Step S30A: determining whether the water level is less than or equal to a third threshold.
Step S30B: if determining the water level is less than or equal to the third threshold, generating the drought notification.
Step S30C: if determining the water level is greater than the third threshold, further determining whether the water level is greater than or equal to a fourth threshold. If determining the water level is less than the fourth threshold, executing step S10 to repeat another cycle of measuring water levels.
Step S30D: if determining the water level is greater than or equal to the fourth threshold, generating the abnormality notification.

In this embodiment, each of the two-dimensional barcodes 40 of the water level gauge 200 is corresponding to a respective one of the measurement values. In other words, different water levels are respectively encoded into the two-dimensional barcodes 40, and each of the two-dimensional barcodes 40 are unique. Therefore, when the two-dimensional barcodes 40 are read in step S20A, different measurement values are also obtained.

In step S20B the processing module 10 then determines the least of the measurement values as the lowest measurement values of water level. Logically, the least of the measurement values should correspond to the actual height of the water level. For example, if the two-dimensional barcodes 40 are numbered into QR code 1 to QR code 5, then examples of the corresponding measurement values are listed in the following table 1.

TABLE 1

| Numbered two-dimensional barcodes | Water Level |
|---|---|
| QR code 1 | 1 meter (m) |
| QR code 2 | 2 m |
| QR code 3 | 3 m |
| QR code 4 | 4 m |
| QR code 5 | 5 m |

If the processing module 10 reads QR code 4 and QR code 5, then the processing module 10 obtains a reading of 4 meters and 5 meters. Then the processing module 10 determines that 4 meters is the least of the two readings, and so the water level is decided to be 4 meters.

Following the determination of the water level, the processing module 10 further determines whether the water level is too high or too low with the third threshold and the fourth threshold. The third threshold and the fourth threshold are stored in the processing module 10, and the third threshold is less than the fourth threshold. When the water level is determined to be less than or equal to the third threshold, the drought notification is generated, as water level is decidedly too low. Vice versa, when the water level is determined to be greater than or equal to the fourth threshold, then the abnormality notification is generated, as water level is decidedly too high, or possibly something is wrong with the camera 20. When the user sees the abnormality notification through the display module 30, the user would best visibly confirm the water levels through the footage displayed by the camera to confirm an abnormal water level status of the body of water.

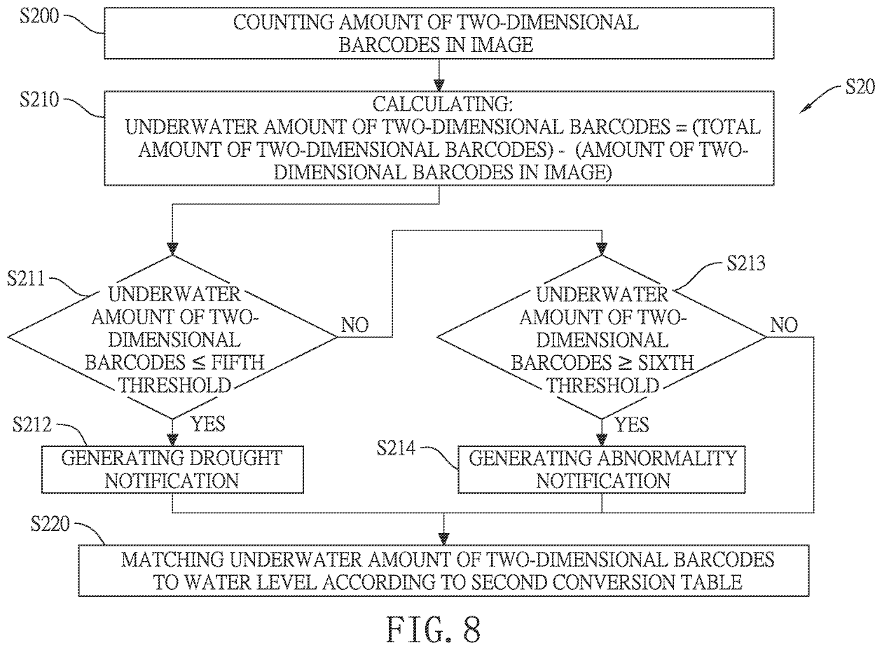

With reference to FIG. 8, in a third embodiment of the present invention, step S20 further includes the following sub-steps:
Step S200: counting the amount of two-dimensional barcodes 40 in the image.
Step S210: calculating an underwater amount of the two-dimensional barcodes 40 as a total amount of the two-dimensional barcodes 40 minus the amount of the two-dimensional barcodes 40 in the image.
Step S211: determining whether the underwater amount of the two-dimensional barcodes 40 is less than or equal to a fifth threshold.
Step S212: if determining the underwater amount of the two-dimensional barcodes 40 is less than or equal to the fifth threshold, generating a drought notification and executing step S220.
Step S213: if determining the underwater amount of the two-dimensional barcodes 40 is greater than the fifth threshold, further determining whether the underwater amount of the two-dimensional barcodes 40 is greater than or equal to a sixth threshold.
Step S214: if determining the underwater amount of the two-dimensional barcodes 40 is greater than or equal to the sixth threshold, generating an abnormality notification and executing step S220.

If determining the underwater amount of the two-dimensional barcodes 40 is less than the sixth threshold, directly executing step S220.

Step S220: matching the underwater amount of the two-dimensional barcodes 40 to the water level according to a second conversion table.

In this embodiment, step S210 determines the underwater amount of the two-dimensional barcodes 40, which provides a different analytical model slightly different than in the first embodiment.

The total amount of the two-dimensional barcodes 40, the fifth threshold, the sixth threshold, and the second conversion table are all stored within the processing module 10. The fifth threshold is less than the sixth threshold. In this embodiment the second conversion table is as below:

Second conversion table

| The underwater amount of | |
|---|---|
| two-dimensional barcodes | Water Level |
| 5 | Over 5 meters (m) |
| 4 | Between 4 m and 5 m |
| 3 | Between 3 m and 4 m |
| 2 | Between 2 m and 3 m |
| 1 | Between 1 m and 2 m |
| 0 | Less than 1 m |

For example, if the underwater amount of the two-dimensional barcodes 40 calculated by the processing module 10 is 4 QR codes, then when the processing module 10 executes step S220 to match the underwater amount of the two-dimensional barcodes 40 to the water level according to the second conversion table, the processing module 10 determines that the water level is between 4 and 5 meters for the body of water.

The above embodiments only demonstrate several possible applications of the present invention, rather than imposing limitations for the present invention. Any equivalent changes from what is claimed and specified by the present invention would be encompassed by what is claimed by the present invention.

What is claimed is:

1. A water level detection method via video recognition, including the following steps:
step S10: obtaining an image of a water level gauge from a camera; wherein the water level gauge includes multiple two-dimensional barcodes; and
step S20: determining a water level according to the two-dimensional barcodes.

2. The water level detection method via video recognition as claimed in claim 1, wherein step S20 further includes the following sub-steps:
counting an amount of the two-dimensional barcodes in the image; and
matching the amount of the two-dimensional barcodes to the water level according to a conversion table.

3. The water level detection method via video recognition as claimed in claim 1, wherein step S20 further includes the following sub-steps:
counting an amount of the two-dimensional barcodes in the image;
determining whether the amount of the two-dimensional barcodes in the image is less than or equal to a first threshold; and
if determining the amount of the two-dimensional barcodes is less than or equal to the first threshold, generating an abnormality notification;
matching the amount of the two-dimensional barcodes to the water level according to a conversion table.

4. The water level detection method via video recognition as claimed in claim 1, wherein step S20 further includes the following sub-steps:
counting an amount of the two-dimensional barcodes in the image;
determining whether the amount of the two-dimensional barcodes in the image is less than or equal to a first threshold;
if determining the amount of the two-dimensional barcodes is less than or equal to the first threshold, generating an abnormality notification;
determining whether the amount of the multiple two-dimensional barcodes in the image is greater than or equal to a second threshold;
if determining the amount of the two-dimensional barcodes is greater than or equal to the second threshold, generating a drought notification; and
matching the amount of the two-dimensional barcodes to the water level according to a conversion table;
wherein the second threshold is greater than the first threshold.

5. The water level detection method via video recognition as claimed in claim 1, wherein step S20 further includes the following sub-steps:
counting an amount of the two-dimensional barcodes in the image;
excluding any mirrored two-dimensional barcodes from the amount of the two-dimensional barcodes counted from the image; and
matching the amount of the two-dimensional barcodes to the water level according to a conversion table.

6. The water level detection method via video recognition as claimed in claim 2, wherein:
all of the two-dimensional barcodes of the water level gauge are identical.

7. The water level detection method via video recognition as claimed in claim 2, wherein:
all of the two-dimensional barcodes of the water level gauge are quick response (QR) codes.

8. The water level detection method via video recognition as claimed in claim 1, wherein the step S20 further includes the following sub-steps:
reading the two-dimensional barcodes for obtaining multiple measurement values; and
obtaining the least of the measurement values as the water level.

9. The water level detection method via video recognition as claimed in claim 1, further including the following steps:
reading the two-dimensional barcodes for obtaining multiple measurement values;
obtaining the least of the measurement values as the water level;
determining whether the water level is less than or equal to a third threshold; and
if determining the water level is less than or equal to the third threshold, generating a drought notification.

10. The water level detection method via video recognition as claimed in claim 1, further including the following steps:
reading the two-dimensional barcodes for obtaining multiple measurement values;
obtaining the least of the measurement values as the water level;
determining whether the water level is less than or equal to a third threshold;
if determining the water level is less than or equal to the third threshold, generating a drought notification;
determining whether the water level is greater than or equal to a fourth threshold; and
if determining the water level is greater than or equal to the fourth threshold, generating an abnormality notification;
wherein the fourth threshold is greater than the third threshold.

11. The water level detection method via video recognition as claimed in claim 8, wherein:
each of the multiple two-dimensional barcodes of the water level gauge is corresponding to a respective one of the measurement values.

12. The water level detection method via video recognition as claimed in claim 8, wherein:
all of the two-dimensional barcodes of the water level gauge are quick response (QR) codes.

13. The water level detection method via video recognition as claimed in claim 1, wherein step S20 further includes the following sub-steps:
counting an amount of the two-dimensional barcodes in the image;
calculating an underwater amount of the two-dimensional barcodes as a total amount of two-dimensional barcodes minus the amount of the two-dimensional barcodes in the image; and
matching the underwater amount of the two-dimensional barcodes to the water level according to a conversion table.

14. The water level detection method via video recognition as claimed in claim 1, wherein step S20 further includes the following sub-steps:
counting an amount of the two-dimensional barcodes in the image;
calculating an underwater amount of the two-dimensional barcodes as a total amount of two-dimensional barcodes minus the amount of the two-dimensional barcodes in the image;
determining whether the underwater amount of the two-dimensional barcodes is less than or equal to a fifth threshold;
if determining the underwater amount of the two-dimensional barcodes is less than or equal to the fifth threshold, generating a drought notification; and
matching the underwater amount of the two-dimensional barcodes to the water level according to a conversion table.

15. The water level detection method via video recognition as claimed in claim 1, wherein step S20 further includes the following sub-steps:
counting an amount of the two-dimensional barcodes in the image;
calculating an underwater amount of the two-dimensional barcodes as a total amount of two-dimensional barcodes minus the amount of the two-dimensional barcodes in the image;
determining whether the underwater amount of the two-dimensional barcodes is less than or equal to a fifth threshold;
if determining the underwater amount of the two-dimensional barcodes is less than or equal to the fifth threshold, generating a drought notification;
determining whether the underwater amount of the two-dimensional barcodes is greater than or equal to a sixth threshold;
if determining the underwater amount of the two-dimensional barcodes is greater than or equal to the sixth threshold, generating an abnormality notification; and
matching the underwater amount of the two-dimensional barcodes to the water level according to a conversion table;
wherein the sixth threshold is greater than the fifth threshold.

16. The water level detection method via video recognition as claimed in claim 13, wherein:
all of the two-dimensional barcodes of the water level gauge are identical.

17. The water level detection method via video recognition as claimed in claim 13, wherein:
all of the two-dimensional barcodes of the water level gauge are quick response (QR) codes.
